(19) United States
(12) Patent Application Publication
(10) Pub. No.: US 2013/0018834 A1
(43) Pub. Date: Jan. 17, 2013

(54) STATE MACHINE RESPONSIVE TO MEDIA SOURCES

(71) Applicant: Reynaldo Amadeu Dal Lin Junior, Curitiba (BR)

(72) Inventor: Reynaldo Amadeu Dal Lin Junior, Curitiba (BR)

(21) Appl. No.: 13/181,607

(22) Filed: Jul. 13, 2011

(51) Int. Cl. G06N 5/00

(52) U.S. Cl. 706/46

(57) ABSTRACT

A state machine includes inputs configured to receive media signals from multiple media sources; state logic configured to respond to receipt of media signals by the inputs; and outputs configured to output logical states where each of the logical states calls for rendering of media from one of the multiple media sources. Various other examples of devices, assemblies, systems, methods, etc., are also disclosed.

### TECHNICAL FIELD

Subject matter disclosed herein relates generally to state machines configured to respond to media sources.

### BACKGROUND

Environments today find an increasing number of media sources. For example, in a vehicle environment, media sources often include a radio, a CD player and a GPS or navigation system as well as one or more passenger cell phones and possibly other personal media devices (e.g., portable media sources). As another example, consider a home environment that includes a cable media source, a satellite media source, and one or more telephones, whether landline, cellular, etc. As yet another example, consider a work environment that includes a computer, an intercom system, and a security system as well as one or more telephones, whether landline, cellular, etc. Most individuals find an environment pleasing when they consume media from a single source. For example, listening to a song received over a car radio while talking on a cell phone is, for many, not a pleasing experience. As described herein, a state machine can respond to media sources and optionally prioritize rendering of media to improve an environment.

Some audio technologies are described in the following documents: BR PI 0602229-4 A, entitled “Sistema Sonoro Para Veículos Automotivos em Geral” (Sound System for Automotive Vehicles”) and published Dec. 26, 2007; BR MU 8802219-6 U2, entitled “Aperfeiçoamentos Introduzidos em Sistema Sonoro para Veículos em Geral” (“Improvement for a Vehicle Sound System”) and published Feb. 2, 2010; BR PI 0802999-7 A2, entitled “Dispositivo Eletronico de Interligação entre Aparelhos Celulares e Aparelhos Reprodutores de Audio” (“Electronic Device Interconnection between Mobile Phones and Devices that Reproduce Audio”) and published Mar. 22, 2011; and BR C10602229-4 E2, entitled “Sistema Sonoro Para Veículos Automotivos em Geral” (Sound System for Automotive Vehicles”) and published Nov. 24, 2009. The four aforementioned published documents, which list Reynaldo Amadeu Dal'Lin Junior as an inventor, are incorporated by reference herein.

### BRIEF DESCRIPTION OF THE DRAWINGS

A more complete understanding of the various methods, devices, circuitry, state machines, assemblies, systems, arrangements, etc., described herein, and equivalents thereof, may be had by reference to the following detailed description when taken in conjunction with examples shown in the accompanying drawings where:

FIG. 1 is a diagram of an example of a system with multiple media sources and circuitry configured to respond to media signals and to call for rendering of media via one or more device;

FIG. 2 is a series of diagrams of examples of logic that include inputs, logical states and outputs;

FIG. 3 is a state diagram for examples of forward state transitions for possible input from two media sources;

FIG. 4 is a state diagram for examples of forward state transitions for possible input from three media sources;

FIG. 5 is a diagram of an example of a system that includes two media sources and circuitry for responding to media signals from the two media sources;

FIG. 6 is a diagram of an example of a method for receiving AC signals and, based on receipt of such signals, providing one or more DC signals as logical output to call for rendering of AC signals;

FIG. 7 is a diagram of an example of a method for receiving a line level audio signal from a portable media device and, in turn, providing logic that calls for rendering of the line level audio signal;

FIG. 8 is a diagram of an example of a system that includes multiple media sources and circuitry;

FIG. 9 is a diagram of an example of a system that includes multiple media sources and circuitry;

FIG. 10 is a diagram of an example of circuitry configured to respond to AC signals from multiple media sources;

FIG. 11 is a diagram of an example of a system that optionally includes the circuitry of FIG. 10;

FIG. 12 is a diagram of an example of circuitry that can prioritize input received wirelessly over input received via wire;

FIG. 13 is a diagram of an example of circuitry configured to receive input and provide output where the circuitry optionally includes a microphone; and

FIG. 14 is a diagram of an example of a system such as a home media system.

### DETAILED DESCRIPTION

Described herein are various examples of state machines and associated equipment as well as examples of methods of using a state machine in conjunction with such equipment. For example, as described herein, a state machine can include inputs configured to receive media signals from multiple media sources; state logic configured to respond to receipt of media signals by the inputs; and outputs configured to output logical states wherein each of the logical states calls for rendering of media from one of the multiple media sources. Such a state machine can be configured to use an input signal or signals from a media source to generate an output signal, for example, indicative of a logic state. As described herein, a state machine may be circuitry configured for receipt of signals (e.g., analog signals) and for response to such signals, for example, to assume or enter a logical state, which may optionally be output as a constant voltage signal (e.g., to achieve a Boolean output). As described herein, depending on configuration, a state machine may perform analog to digital conversion, for example, where an analog media signal is input and a digital control signal is output. Such a conversation may optionally occur automatically in response to receipt of one or more analog media signals. As to output, such output may instruct circuitry to render one or more analog media signals. As described herein, such output may optionally instruct circuitry to record or otherwise store one or more analog media signals (e.g., optionally in addition to rendering for listening, etc.).

In various examples, a state machine includes inputs configured to receive analog media signals. As described herein, a state machine can include circuitry configured to transform an analog media signal to a constant voltage signal, which may be provided to an output (e.g., an output configured to output constant voltage signals).

In various examples, a state machine includes inputs configured to receive analog audio signals and circuitry configured to transform an analog audio signal to a constant voltage signal. As described herein, an input or inputs may be configured to receive analog audio signals from a media source configured to output audio and video signals. In such examples, as well as other examples, one or more inputs can optionally include at least one input configured to receive media signals wirelessly (e.g., IR, RF, etc.). As described herein, a state machine can include priority logic to prioritize at least one of the inputs (e.g., over one or more other inputs).

As described herein, at least one of multiple media sources can include a media source configured to receive power from a 12 volt power system, a media source configured to receive power form a lithium ion battery, etc. For example, consider a vehicle environment that includes an audio system powered by the vehicle's power system and a personal media device powered by a lithium ion battery (e.g., or other power source that may be distinct from the vehicle's power system). As described herein, a state machine and at least one of multiple media sources may be configured to operate on a common power circuit. For example, a common power circuit of a vehicle may include a fuse or circuit breaker of a rating sufficient to handle load of a media source and a state machine and optionally associated circuitry. Such a configuration can readily allow for installation of a state machine on an existing power circuit that powers a media source such as a vehicle audio system (e.g., radio, radio/CD, radio/DVD, CD player, DVD player, GPS, etc.). As described herein, a vehicle audio system may be considered as providing at least audio and optionally video.

As described herein, multiple media sources can include a portable media device and a media device configured to read removable media (e.g., memory cards, optical disks, etc.). As described herein, multiple media sources can include at least one media source selected from a group consisting of a game device, an audio-video camera, a DVD player, a CD player, a personal computer, a cell phone, a vehicle computer, and a GPS device.

As described herein, multiple media sources can include a cell phone connected by wire to an input of a state machine and a cell phone connected wirelessly to another input of a state machine. As an example for prioritizing one source over another, consider a RC circuit configured to receive media signals via one of the inputs configured for wireless receipt of media signals and to prioritize rendering of media from a media source that provides the media signals wirelessly. Such an RC circuit may include one or more transistors (e.g., NPN transistors) and may optionally include one or more diodes.

As described herein, a media player can include an internal media source for providing media signals; an input configured to receive media signals from an external media source; and state logic configured to respond to media signals from the internal media source and to media signals from the external media source by calling for rendering of media from the internal media source or rendering of media from the external media source. Such a media player may optionally include more than one internal media source (e.g., a card reader, an optical disk reader, memory, radio receiver, etc.).

As described herein, a media signal amplifier can include inputs configured to receive media signals from multiple media sources; and state logic configured to respond to receipt of media signals by the inputs by calling for amplification of media from one of the multiple media sources. Such an amplifier may be an audio amplifier such as a home media amplifier to amplify media received via cable, radio, satellite, etc. and optionally media received via one or more telephones (e.g., landline, cellular, satellite, etc.).

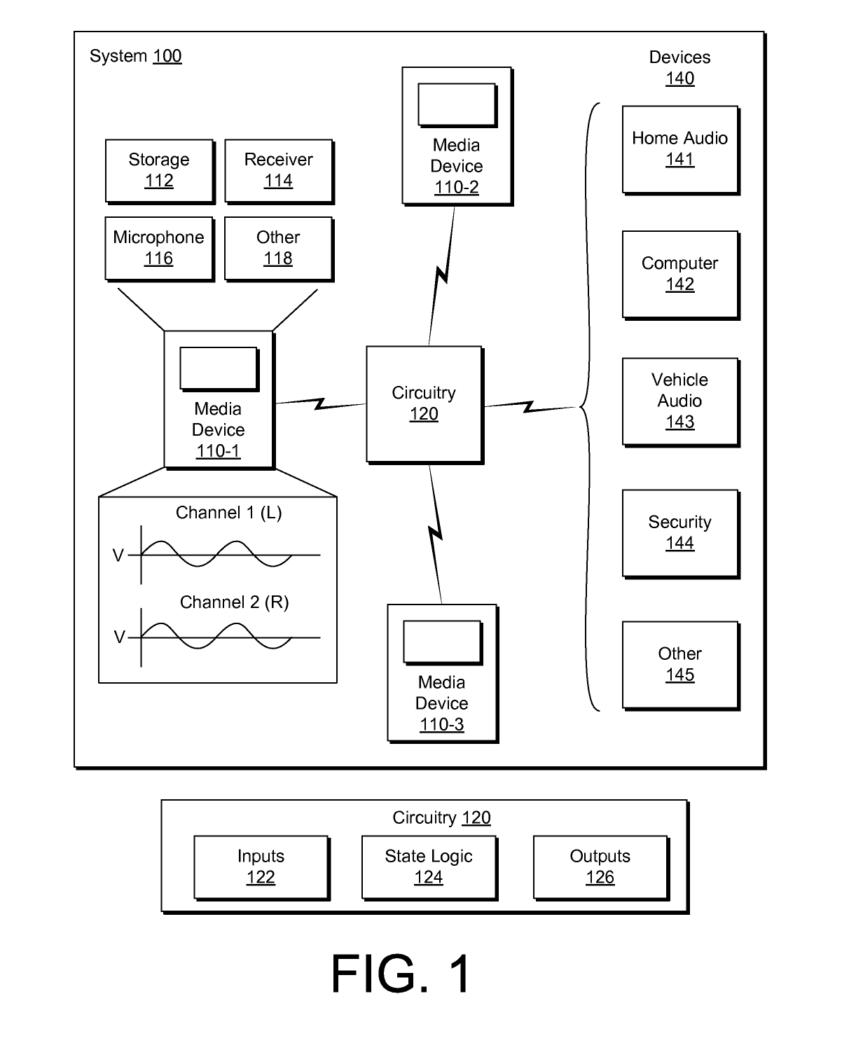

FIG. 1 shows an example of a system 100 that includes multiple media sources 110-1, 110-2 and 110-3 configured to provide signals to circuitry 120, which includes inputs 122, state logic 124 and outputs 126. As shown, each of the media sources 110-1, 110-2 and 110-3 may include components such as media storage 112 (e.g., memory), a receiver 114 (e.g., for RF or other signals), a microphone 116 or other types of components 118.

As shown in the example of FIG. 1, the circuitry 120 may be configured to respond to media source inputs and, in turn, provide output to, directly or indirectly, cause rendering of media of a media source 110-1, 110-2 or 110-3 by one or more devices 140. Such devices may include home audio devices 141, computer devices 142, vehicle audio devices 144, security devices 144 or other devices 145. While rendering is mentioned, output may, directly or indirectly, cause one or more operations such as rendering, storing, transmitting, etc.

Referring to the media source 110-1, a stereo audio signal is shown as including Channel 1 (e.g., a left channel) and Channel 2 (e.g., a right channel). As described herein, such audio signals may be received by the circuitry 120 and transformed into logic to cause rendering of these audio signals by one or more of the devices 140. Specifically, the audio signals themselves, their presence or absence, can provide for output signals that represent logical states.

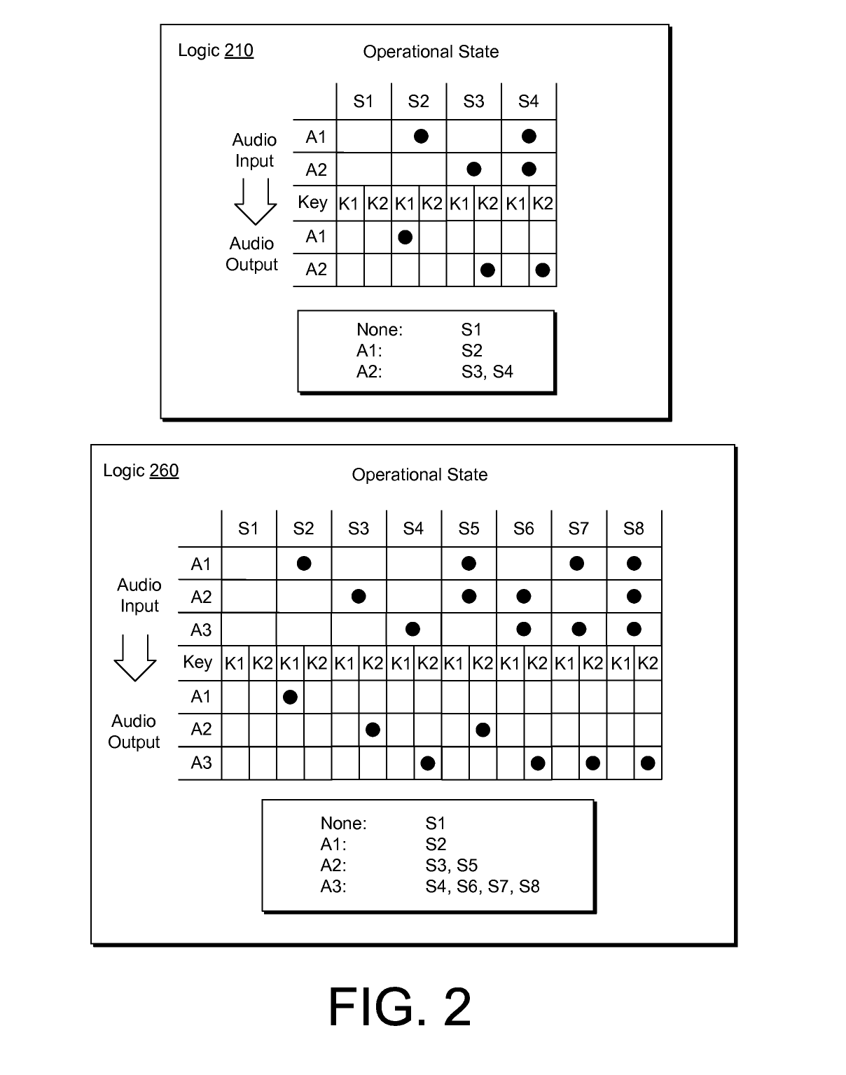

FIG. 2 shows some examples of logic diagrams for two audio input sources 210 and for three audio input sources 260. In each of the diagrams 210 and 260, filled circles represent presence of audio input (e.g., A1, A2 or A3) and presence of logical output keys (K1 or K2). For the two inputs of the logic 210, four states exist (S1, S2, S3 and S4), which, for the example shown, correspond to no rendering, rendering of audio input A1 or rendering of audio input A2. For the three inputs of the logic 260, eight states exist, which correspond to no rendering, rendering of audio input A1, rendering of audio input A2 or rendering of audio input A3. As indicated, for the logic 210 and the logic 260, A2 has priority over A1 while for the logic 260, A3 has priority over A1 and A2.

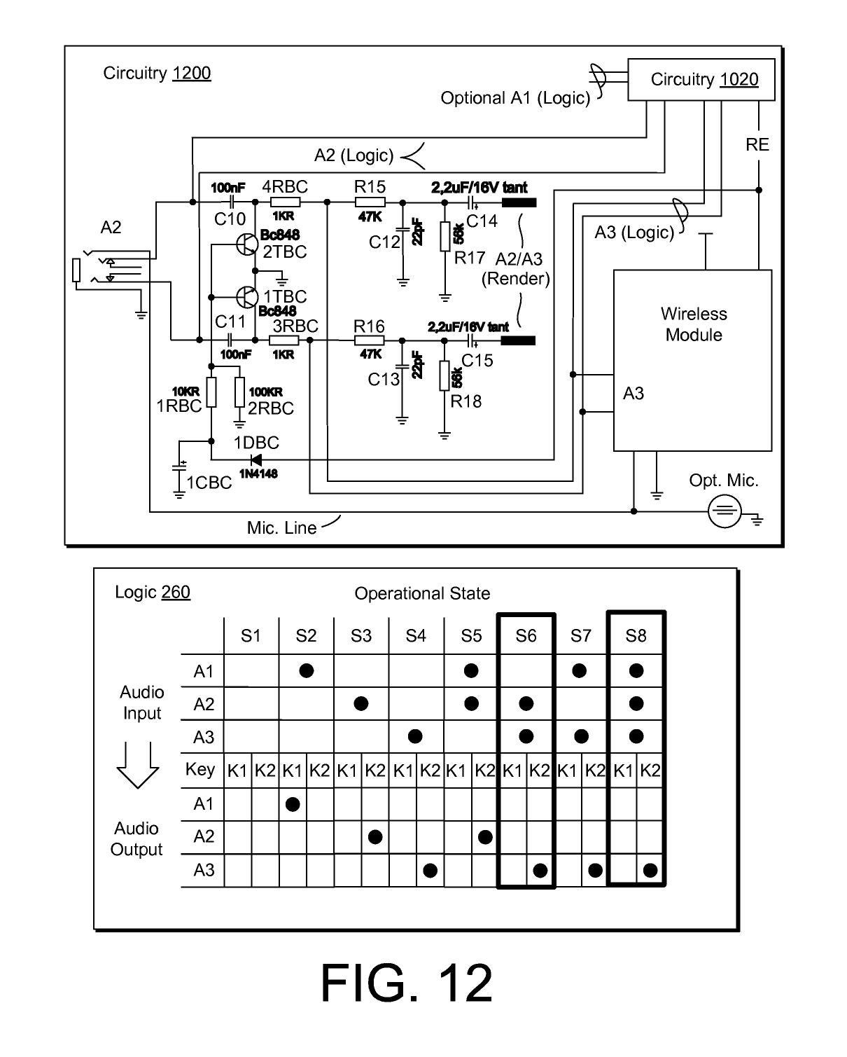

As described herein, K2 of the logic 260 may be redundant for A2 and A3 and audio output controlled via logic circuitry that operates to prioritize transmission of audio input A3 over audio input A2. A detailed example of such circuitry is described with respect to FIG. 12 (see, e.g., lines labeled “logic” and “render” for A2 and A3). As described herein, logic circuitry can optionally include circuitry such as the circuitry shown in FIG. 12 wherein, for example, overall logic can be determined responsive to receipt of analog audio signals by a connector for A2 and a wireless module for A3 (and optionally A1 if provided as an input to circuitry 1020).

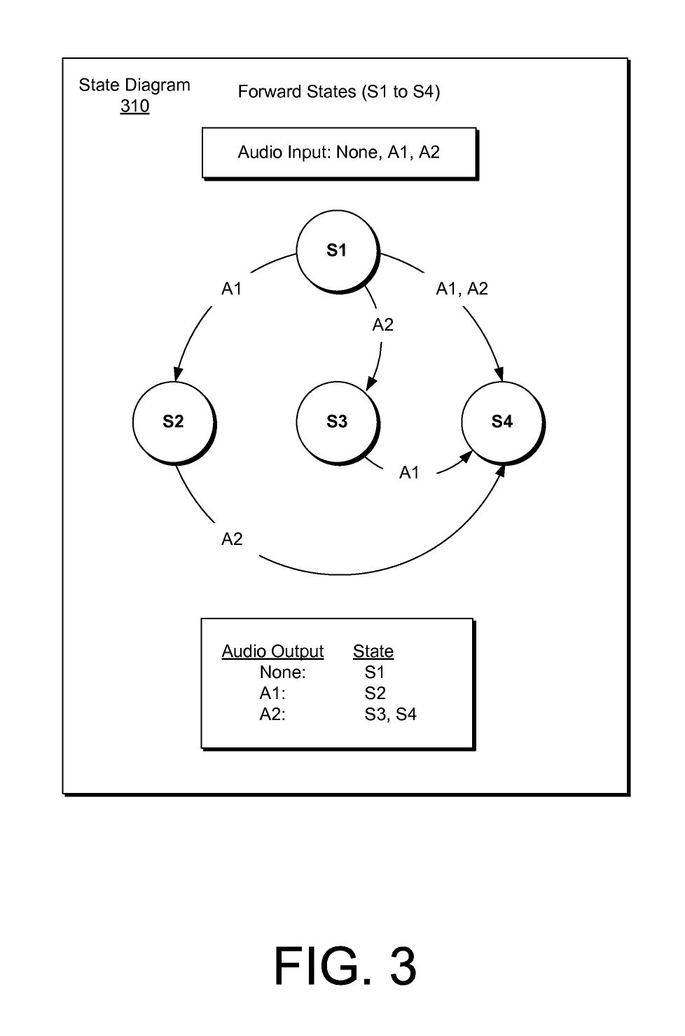

FIG. 3 shows a state diagram 310 for the logic 210 of FIG. 2, specifically for forward state transitions. State S1 corresponds to no input, which can transition to states S2, S3 or S4 depending on whether input is received for A1, A2 or A1 and A2. Further, for states S2 and S3, where additional input is received, transitions can occur to state S4. For example, where A1 is a vehicle CD player and A2 is a cell phone, upon receipt of audio signals from the cell phone, a state machine can prioritize rendering of audio signals of the cell phone over audio signals of the vehicle CD player. As mentioned with respect to FIG. 1, such a state machine can provide for such a state transition based on the audio signals themselves.

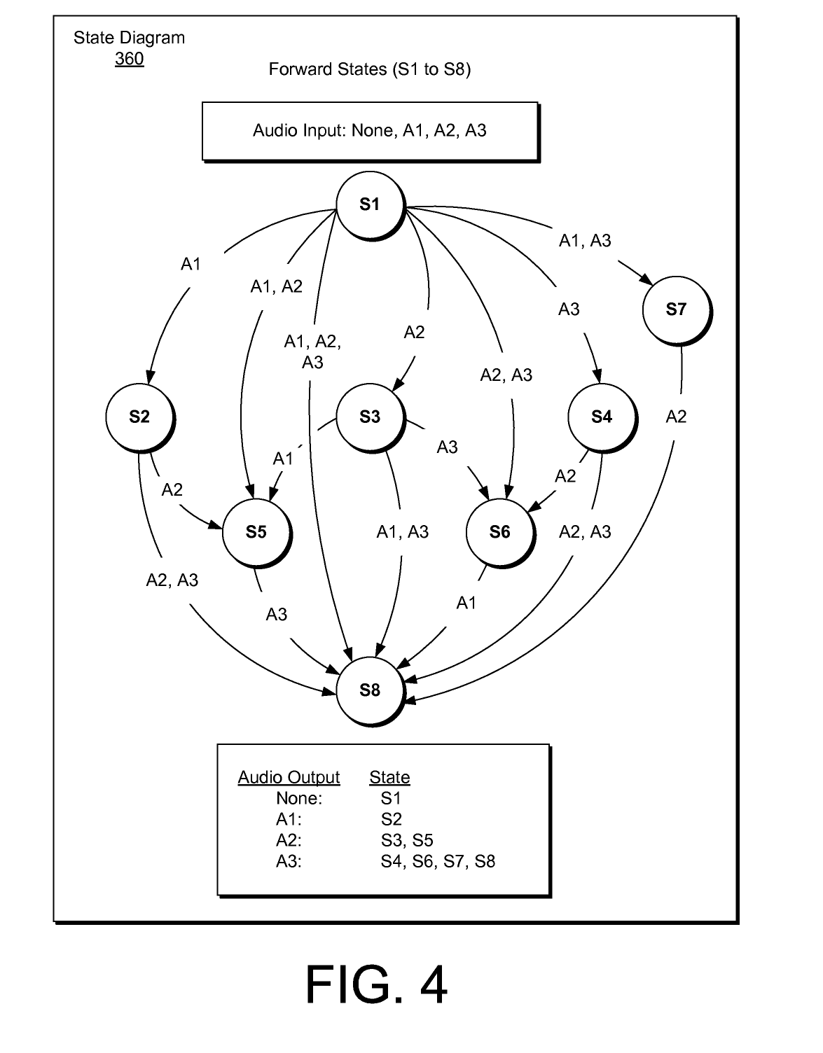

FIG. 4 shows a state diagram 360 for the logic 260 of FIG. 2, specifically for forward state transitions. As an example, consider state S5 where A1 is a vehicle radio, A2 is a cell phone and A3 is another cell phone. In such an example, upon receipt of audio signals from the cell phone A3, a state machine can prioritize rendering of audio signals of the cell phone A3 over audio signals of the vehicle radio player A1 and the other cell phone A2, as represented by the transition to state S8. Such a mechanism may optionally be provided by a circuit (e.g., an RC circuit that can include transistors) configured to receive wired input from A2 and wireless input from A3 (e.g., via BLUETOOTH® standard(s), Bluetooth Signal, Inc., Kirkland, Wash., US, or other wireless means). In other words, particular circuitry may provide for priority of A2 over A1 and other circuitry may provide for priority of A3 over A2. As mentioned with respect to FIG. 1, such a state machine can provide for such a state transition based on the audio signals themselves.

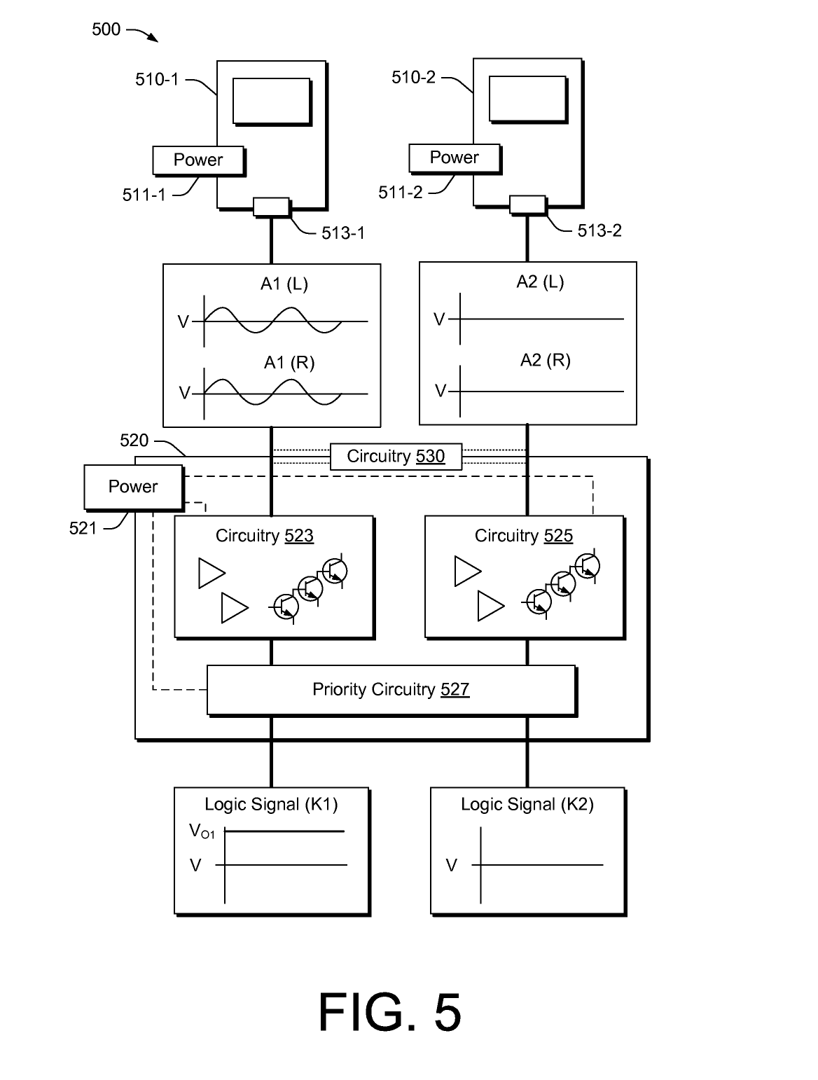

FIG. 5 shows an example of a system 500 that includes media sources 510-1 and 510-2 and circuitry 520. As shown, the media sources 510-1 and 510-2 include power supplies 511-1 and 511-2 as well as interfaces 513-1 and 513-2, which provide for transmission of signals to the circuitry 520.

In the example of FIG. 5, the circuitry 520 includes circuitry 523 configured for receipt of signals from media source 510-1 and circuitry 525 configured for receipt of signals from media source 510-2. Further, the circuitry 520 includes a power supply 521 and priority circuitry 527. The circuitry 520 may optionally include circuitry 530, as integrated circuitry or otherwise provided as intermediate circuitry configured to receive signals from one or more media sources and to transmit such signals to, for example, circuitry 523 or circuitry 525 or both. As indicated, where the media source 510-1 provides audio signals A1 and the media source 510-2 provides no audio signals, the circuitry 520 outputs a logic signal K1 as a constant voltage signal (e.g., a DC signal). The logic signal K1 can call for rendering of audio signals A1 from the media source 510-1. Such rendering may occur by a separate device or optionally a device that includes the circuitry 520.

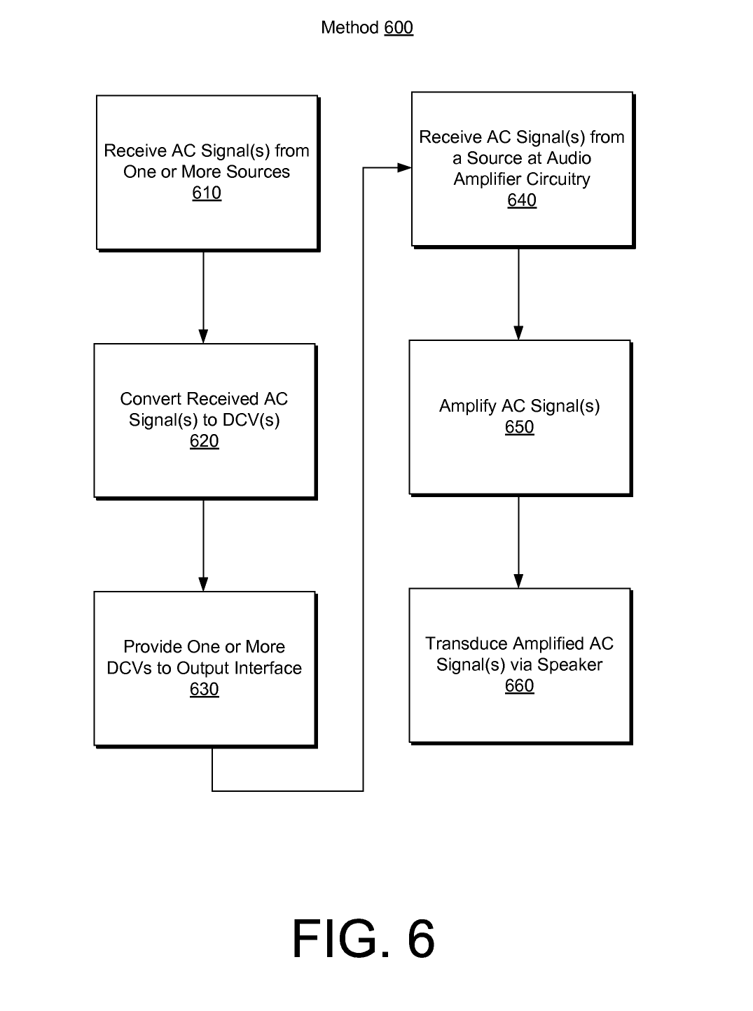

FIG. 6 shows an example of a method 600 where a reception block 610 provides for receiving AC signal(s) from one or more sources, a conversion block 620 provides for converting received AC signal(s) to DCV(s), a provision block 630 provides for providing one or more DCVs to an output interface, a reception block 640 provides for providing AC signal(s) from a source at audio amplifier circuitry, an amplification block 650 provides for amplifying AC signal(s) and a transducer block 660 provides for transducing the amplified AC signal(s) via speakers (e.g., to allow someone to hear, “consume” or “experience” the audio).

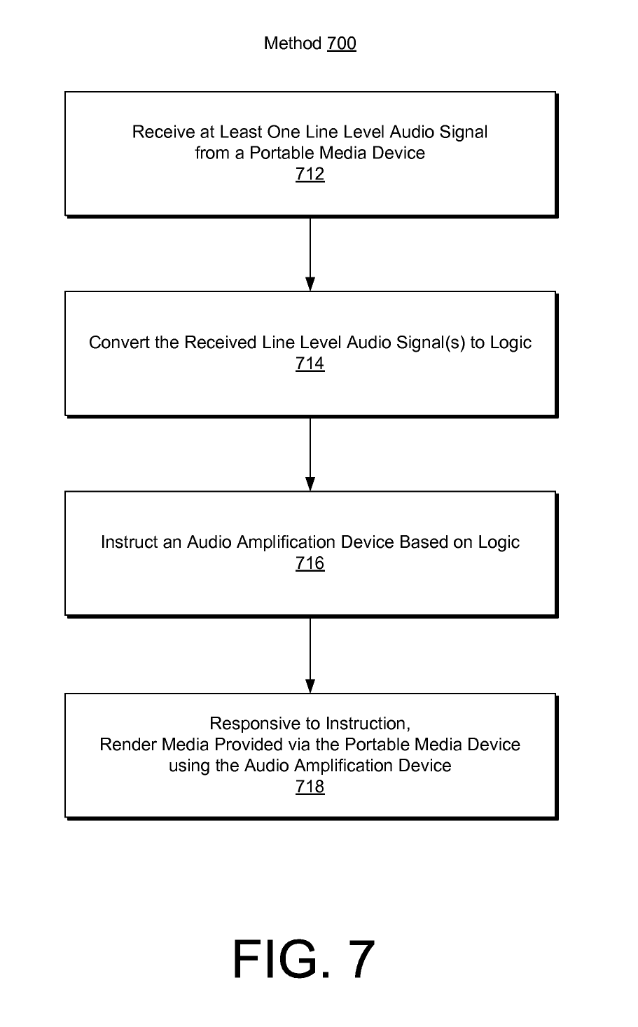

FIG. 7 shows an example of a method 700 where a reception block 712 includes receiving at least one line level audio signal from a portable media device (e.g., a media source), a conversion block 714 includes converting the received line level audio signal(s) to logic, an instruction block 716 includes instructing an audio amplification device based on the logic, and a render block 718 includes rendering, responsive to instruction, of media provided via the portable media device, using the audio amplification device.

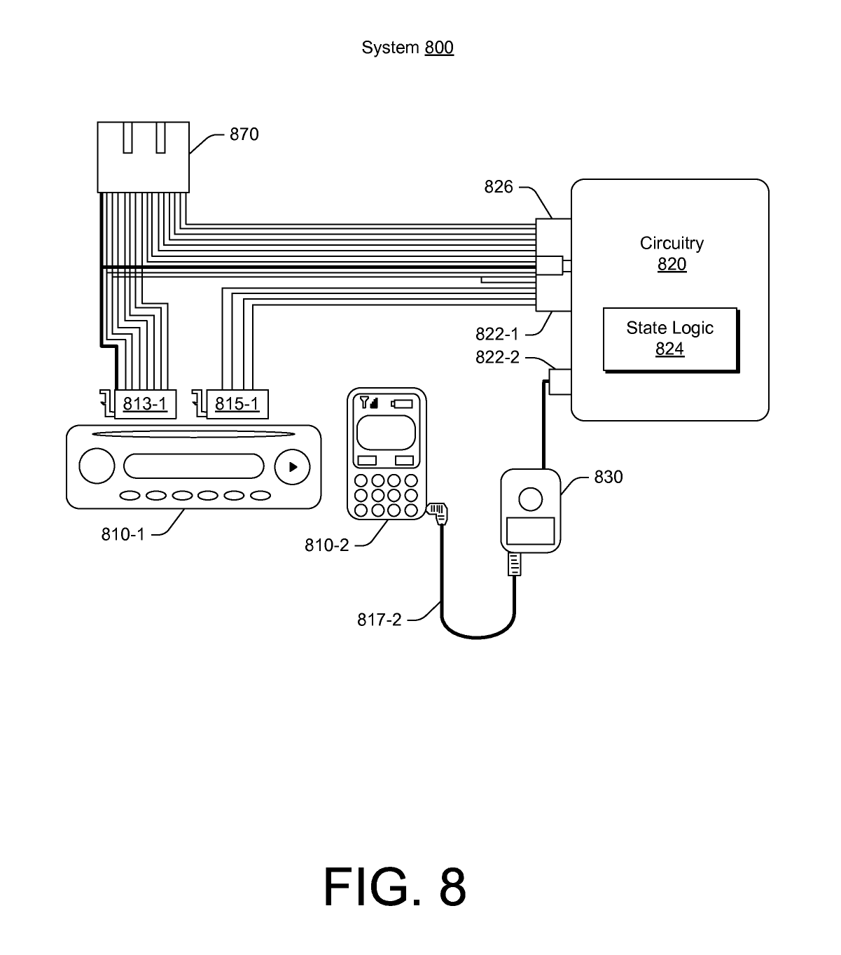

FIG. 8 shows an example of a system 800 that includes media sources 810-1 and 810-2 as well as circuitry 820, which includes state logic 824. As described herein, the circuitry 820 can respond to media signals received from the one or more media sources 810-1 and 810-2 and provide output to call for rendering of media signals from a select one of the media sources 810-1 or 810-2.

In the example of FIG. 8, a wiring harness is show as including various connectors 813-1, 815-1, 822-1, 826, and 870. In such an example, the harness may be a specialized harness with connectors and wiring that comply with standards of conventional audio systems such as those commonly found in vehicles as well as including connectors and wiring that comply with the inputs and outputs of the circuitry 820.

In the example of FIG. 8, the media source 810-1 may be considered an installed vehicle audio media source A1, the media source 810-2 may be considered a cell phone audio media source A2 and the circuitry 820 may be configured according to the logic 210 and the state diagram 310 or optionally the logic 260 and the state diagram 360 (e.g., for three audio inputs A1, A2 and A3).

Also shown in FIG. 8 is a connection box 830, which may be mounted in an environment to allow for a wired connection between a media source and circuitry 820. In the particular example of FIG. 8, the connection box 830 provides a jack for receipt of a cable 817-2 to connect the cell phone 810-2 to the circuitry 820 (e.g., via an input connector 822-2).

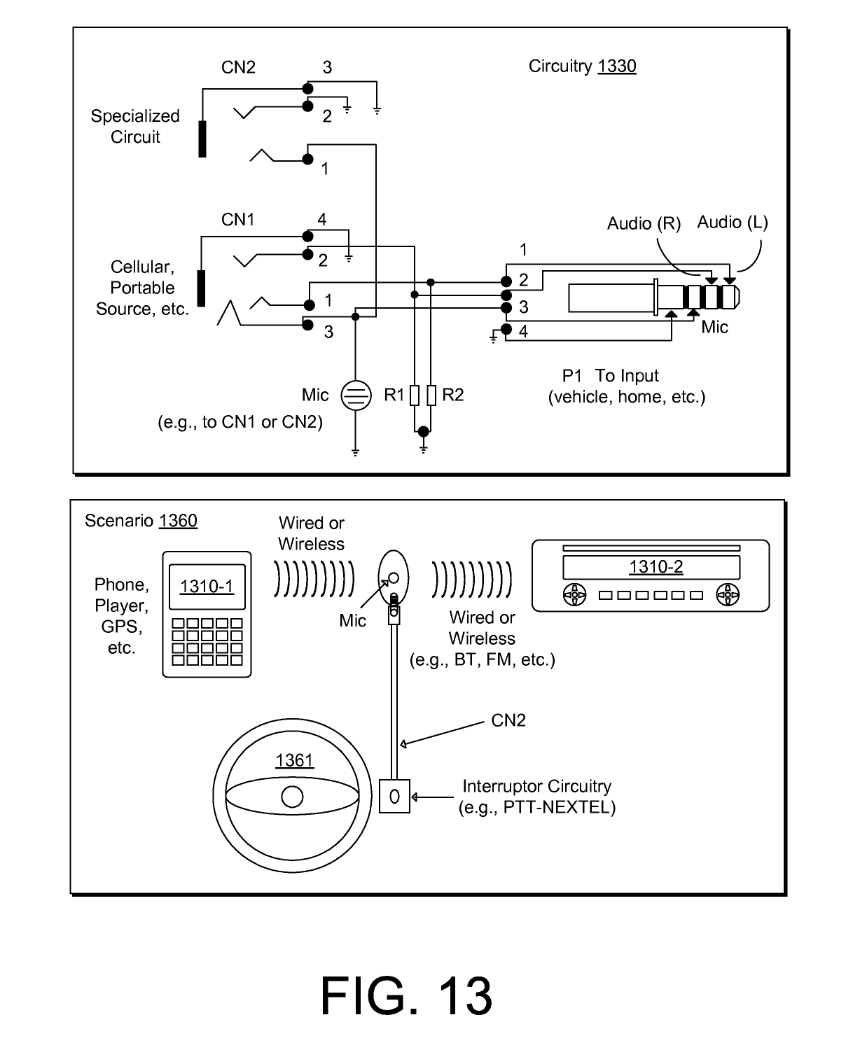

For wireless communication from a cellular phone (e.g., BLUETOOTH® standard), most conventional “hands-free” configurations require a separate microphone. As described herein, the connection box 830 can include a microphone that is automatically activated when a wireless module such as a BLUETOOTH® module that may be included as part of the circuitry 820 receives signals from a cellular phone. Where priority logic decides that the cellular phone connected via a wireless connection has priority, circuitry of the connection box 830 may automatically activate a microphone such that user voice can be received and communicated to the circuitry 820 for proper routing, especially for communication to a caller. An example of such connection box circuitry is shown in FIG. 13. As another example, the circuitry 820 may include an integrated microphone or microphone circuitry such that a separate connection box is not required. In other words, circuitry of the box 830 may be integrated into the circuitry 820.

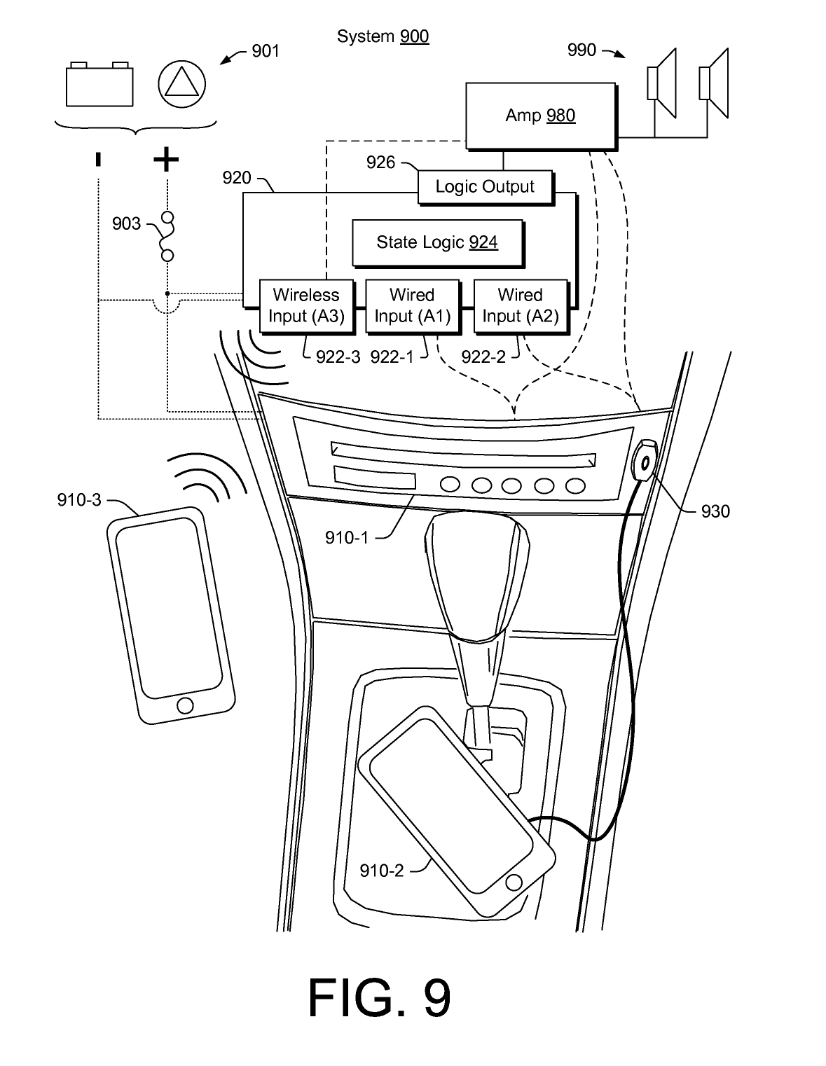

FIG. 9 shows an example of a system 900 that includes various media sources 910-1, 910-2 and 910-3 in an environment that includes a power supply system 901 with a breaker or fuse 903, circuitry 920 with inputs 922-1, 922-2 and 922-3, state logic 924 and logic output 926 and that includes an amplifier 980 and speakers 990.

As shown in FIG. 9, the input 922-1 (A1) is a wired input for receipt of media signals from the media source 910-1 (e.g., an installed media source), the input 922-2 (A2) is a wired input for receipt of media signals from the media source 910-2 (e.g., via the connection box 930), and the input 922-3 (A3) is a wireless input for receipt of media signals from a media source such as the media source 910-3.

As described herein, the circuitry 920 may be configured to operate in accord with the logic 260 of FIG. 2 and provide for state transitions as shown in the logic diagram 360 of FIG. 4. For example, where one passenger is talking on the cell phone 910-2 with audio amplified by the amplifier 980 and audible via the speakers 990 and another call is received by the cell phone 910-3, the call received by the cell phone 910-3 causes receipt of an audio signal by the wireless input 922-3, which, in turn, causes the logic output 926 to output a logic signal to the amplifier 980 to render the audio from the cell phone 910-3 rather than rendering the audio from the cell phone 910-2. As mentioned, priority of input from 910-3 over 910-2 may optionally be achieved via circuitry that causes signals from 910-3 to be transmitted to amplification circuitry rather than signals from 910-2 (also consider, e.g., redundancy of K2, which may be activated by A2 or A3). Again, as mentioned, such circuitry to cause transmission of media signals may be configured to respond automatically to receipt of media signals.

In the aforementioned example, where the media source 910-1 is “on” and playing media, once the phone calls terminate from the cell phones 910-2 and 910-3, the circuitry 920 provides logic output 926 to instruct the amplifier to render media from the media source 910-1. Such an example demonstrates backward transitions in a state diagram. Accordingly, circuitry 920 provides for forward and backward state transitions to automatically enhance an environment with respect to media from one or more media sources. As mentioned, a connection box such as the connection box 930 may include a microphone for receipt of voice from a user and for transducing a voice to electrical signals.

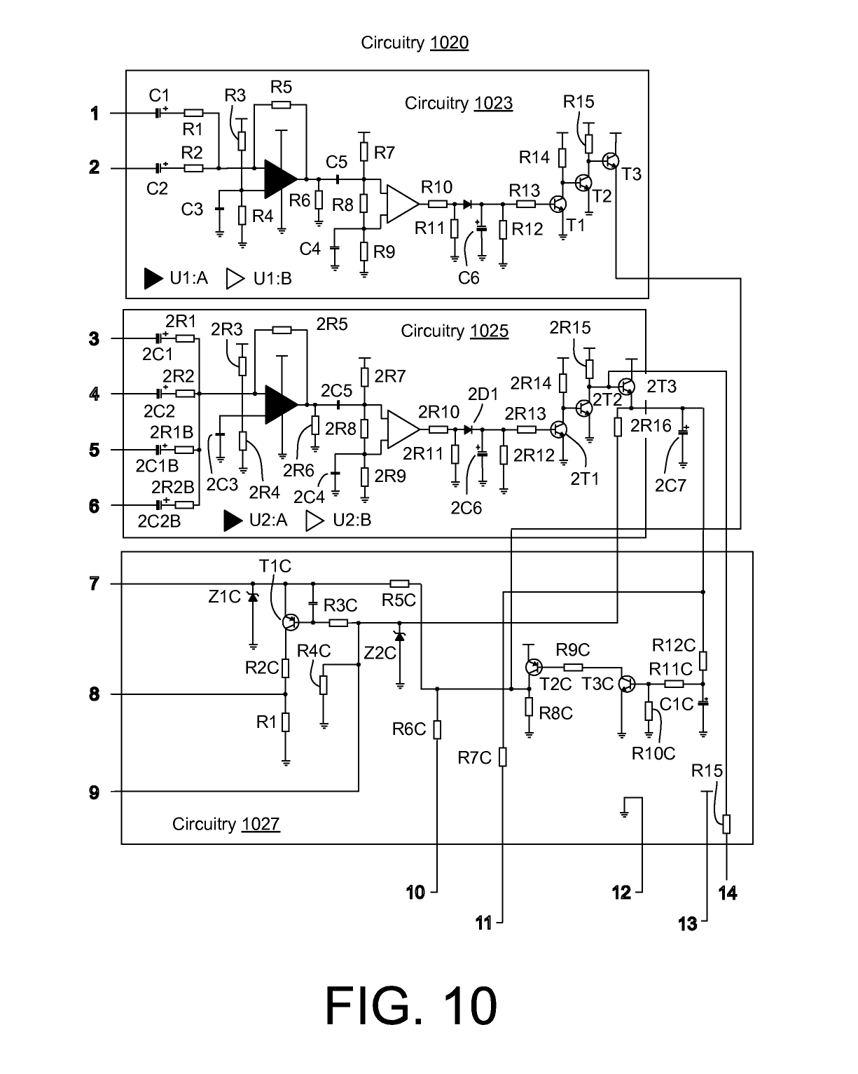

As described herein, various particular forms of circuitry can provide for logic to automatically enhance an environment with respect to rendering of media from one or more media sources (e.g., to prioritize and provide for appropriate forward and backward state transitions). A particular example is shown in FIG. 10.

FIG. 10 shows circuitry 1020 as including circuitry 1023, circuitry 1025 and circuitry 1027. The circuitry 1020 can detect the presence of audio signals on its inputs and, in turn, output logic. The circuitry 1020 can also provide for maintaining an audio signal for a time after its extinction (e.g., gradual decay for improving environmental experience).

Various components of the circuitry 1020 may be powered via a stabilized power circuit, for example, configured to provide a stabilized voltage from a 12 V DC source (e.g., a vehicle power source). Such a stabilized power circuit may be configured using a voltage regulator to output a voltage of approximately 9 V DC (e.g, consider the commercially available regulator LM78L09). A stabilized power circuit may also include capacitive filters.

Referring to the circuitry 1025, this circuitry can amplify an audio signal received at inputs. As shown, the circuitry 1025 includes two operational amplifiers (U2:A and U2:B), which may be commercially available components (e.g., TL082). In the circuitry 1025, voltage gain is given by the ratio of resistors 2R5 and 2R1 (2R2, 2R1B, 2R2B), attached to the circuit (e.g., 150K/1K to provide a voltage gain of 150×).

The circuitry 1025 includes audio inputs 3 and 4 (e.g., stereo inputs via Terminals 3 and 4), where capacitors 2C1, 2C2, 2C1B, 2C2B function to prevent signal DC (direct current) to pass the stage of amplification, as the circuitry 1025 is configured to amplify only at least a portion of the audio signal (AC signal). After passing 2R1, 2R2, 2R1B, 2R2B audio signals of two channels are added to provide for further amplification. The resistors 2R3 and 2R4 form a resistive divider providing half the DC voltage input of the non-inverting operational amplifier (U2: A), this voltage will be added to the audio signal before amplification, which is desirable as the audio signal is AC and the operational amplifier is asymmetric. The capacitor 2C3 acts as a filter for the signal. The resistor 2R6 acts as an impedance to ground in an output gain stage.

As to the operational amplifier U2:B, this stage of the circuitry 1025 provides for detection of amplified audio. The operational amplifier U2:B has a comparator configuration configured to compare the audio signal with a predetermined reference voltage. For example, when the audio signal is greater than the reference voltage circuit, this stage indicates presence of audio (e.g., high TTL voltage).

In the second stage, the resistors 2R7, 2R8 and 2R9 form a resistive divider providing the reference voltage at the inverting and non inverting inputs of the operational amplifier U2:B, where the inverting input is positive compared to non-inverting input. Thus, where no audio signal is applied to the inputs, the output of the operational amplifier provides a low level (e.g., low TTL voltage).

In the circuitry 1025, a capacitor 2C5 allows only AC signal (audio) to pass from the previous stage of amplification (i.e., per U2:A) to the next stage (U2:B). The signal (audio) has a small portion passing through the resistors 2R8 and 2R9 going to ground and a greater portion passing through the resistors 2R8 and 2C4, 2C4 to provide an AC impedance that is much smaller than 2R9. When the audio signal (AC) is in a positive half cycle, it generates a positive voltage across the resistor 2R8 that adds to the reference voltage and, correspondingly, the operational amplifier U2:B provides a low TTL voltage. However, when this signal is in a negative half cycle, it provides a negative voltage across the resistor 2R8, which, if the signal is greater than the negative voltage reference, a negative voltage is applied at the inverting input with respect to the non-inverting input. As a consequence, the output of the operational amplifier U2:B provides a high TTL voltage. In the example of FIG. 10, the value of the capacitor 2C4 comports with the frequency from which the audio signal acts in the detection, where the higher the value of 2C4, the lower the frequency and vice versa.

When the output of the operational amplifier U2:B provide a high TTL level, it provides current through the resistor 2R10, which acts to charge the capacitor 2C6 (just past the diode 2D1). In the circuitry 1025, the resistors 2R10, 2R11, 2R12 and 2R13 determine a charging time of the capacitor 2C6. When output of the operational amplifier U2:B goes to a low TTL level, the diode 2D1 prevents the capacitor 2C6 from discharging through resistors 2R10 and 2R11, thus allowing discharging only through the resistors 2R12 and 2R13. Accordingly, it is possible to determine different times of loading and discharging of the 2C6, where, in general, load time is less than the time of discharge. In the example of FIG. 10, the charging time determines the speed at which the circuit output indicates presence of audio while discharge time determines the speed of indicating absence of audio. As described herein, the dynamics of the circuitry 1025 can comport with AC audio signal (e.g., frequencies between approximately 20 Hz and approximately 20 KHz). Without such provisions, in the logic stage of the circuitry 1025, output of the circuit would tend to switch between high and low with respect to audio frequencies.

In the example of FIG. 10, the circuitry 1025 includes an output stage with various transistors 2T1, 2T2 and 2T3. The output state functions to determine output logic and to supply current to the circuitry 1027.

In the circuitry 1025, when the capacitor 2C6 from the previous stage is loaded, it provides current through the resistor 2R13 to the base of transistor 2T1, which, in turn, has its collector in a low level logic state that prevents current from flowing through the base of transistor 2T2. Accordingly, the transistor 2T2 is not conducive to maintaining high collector impedance. In this condition, current passes through the resistor 2R15 to the base of the transistor 2T3, which, in turn, leads to supply of current to the resistor 2R16, which feeds and brings a full load to the capacitor 2C7, and in the absence of audio signal inputs at 3 and 4 (Terminals 3 and 4) to determine the discharge of 2C7 where the time of discharge determines whether or not to have voltage on the outputs 8 and 9 (e.g., logic state outputs such as Key 1 and Key 2, also referred to as Terminals 8 and 9 of the circuitry 1027). The value of the resistor 2R16 can be selected as being related to the maximum current supplied to a connected circuit. In the example of FIG. 10, the capacitor 2C7 acts as a filter and power back-up to allow for a change of logic level on the outputs 8 and 9 (Key 1 “K1” and Key 2 “K2”; Terminals 8 and 9 of the circuitry 1027).

For the circuitry 1025, when the capacitor 2C6 is unloaded, it ceases to provide power to the base of transistor 2T1, which, in turn, has high collector impedance. In this condition, current passes through the resistor 2R14 going to the base of transistor 2T2, which, in turn, has its collector at a low logic level that prevents current from flowing through the base of the transistor 2T3. In this condition the transistor 2T3 will fail to supply current through resistor 2R16, thereby discharging capacitor 2C7 and indicating a lack of audio input.

For the circuitry 1023, functioning may be similar to that of the circuitry 1025. As an example, the circuitry 1023 may be configured such that the gain is approximately 47 times instead of approximately 150 times, as in the example provided for the circuitry 1025. The difference (about 3× greater gain for the circuitry 1025) may be for scenarios where inputs to the circuitry 1023 are greater than for the circuitry 1025. For example, where the circuitry 1023 receives audio signals coming from a CD player (or DVD player) as a media source and where the circuitry receives audio signals coming from a cell phone, more amplification is required of the cell phone audio signals. Specifically, audio signal output power from a cell phone is generally less than audio signal output power of a CD/DVD media player.

As to the circuitry 1027, in the example of FIG. 10, it is configured to be responsible for all the output voltage signals of the circuitry 1020, which may be a state machine. A general description of how the circuitry 1027 may function can be provided with respect to Terminals 7, 8, 9, 10, 11, 12, 13, and 14.

In the configuration shown, Terminal 7 is responsible for providing a 5 V DC constant supply, where the diode Z1C is responsible for reducing the amount of incoming voltage to a level of about 5 V. After reduction, this voltage is applied to the emitter of T1C transistor, which is responsible for providing 5 V to the Terminal 8 (Key 1 or Channel 01). The transistor T1C is a PNP transistor and through R4C, is referred to the ground of the circuit and to the basis of the T1C via R3C, where saturation of the transistor T1C provides for changing resistance between the collector and the emitter to near zero ohms. For such a scenario, the circuitry will provide 5 V to supply Terminal 8 (Key 1 or Channel 01), where R1 is responsible for stabilization of the transistor T1C, for example, to avoid its fluctuation between saturated and desaturated states.

In the configuration shown, Terminal 9 is responsible for providing a 5 V supply (e.g., Key 2 or Channel 02). This part of the circuitry 1027 includes the resistor R4C for stabilization of the diode Z2C, which is responsible for a reduction of the voltage to approximately a 5 V level. The resistor 2R16 is responsible for reducing amount of current that will be applied over the diode Z2C and that coming from the emitter terminal of the transistor 2T3; noting that the resistor 2R16 is connected direct to the base of the transistor T1C and every time that the transistor 2T3 is saturated, the condition of the transistor T1 C is desaturated thereby changing Terminal 8 (Key 1 or Channel 01) to OFF. In summary, every time audio signals are transmitted via the circuitry 1025, the levels of Terminal 8 (Key 1 or Channel 01) changes to 0 V (low logic) and Terminal 9 (Key 2 or Channel 02) changes to 5 V (high logic).

As shown, Terminal 10 corresponds to 12 V for a remote 01. In this portion of the circuitry 1027, for the example shown, Terminal 10 will always provide 12 V DC as voltage that is coming from the circuitry 1023 via R6C, which is connected to the emitter of the transistor T3. Accordingly, every time that this transistor enters into a saturated state, there will be 12 V DC on Terminal 10, a situation that occurs every time audio signals are present for the circuitry 1023 inputs.

In a second stage of analysis, every time that the transistor 2T3 is saturated, saturation of the transistor T3C is provided through R12C and R11C and, at the same time, the transistor T3C is also responsible for the saturation of the transistor T2C through R9C. In such a manner, the circuitry provides 12 V DC on Terminal 10 whenever audio signals are applied to the inputs of the circuitry 1025.

As shown, Terminal 11 corresponds to 12 V for a remote 02. In this portion of the circuitry 1027, for the example shown, every time that the transistor 2T3 is saturated, through R7C, 12 V DC is provided on the outlet Terminal 11. Accordingly, 12 V DC is available on Terminal 11 every time audio signals are received via inputs to circuitry 1025. As described, Terminal 11 will have 12 V output only when audio is applied to the inputs of 1025 circuitry and this output can be used, for instance, when it is desired to issue a pause command, for example, to a CD player that is connected to the inputs of the circuitry 1023.

As an example, consider receiving a call via a cell phone connected to the circuitry 1025, which enables 12 V at Terminal 11 where this 12 V signal can be used to issue a pause command on a CD or DVD player that is connected to the circuitry 1023.

As shown in FIG. 10, Terminal 12 is to ground (e.g., for a power supply) and Terminal 13 is a positive of a power supply.

As shown, Terminal 14 is provided as an external remote control that changes the condition of the transistor 2T3 to saturated, which can shift Terminal 8 (Key 1 or Channel 01) to 0 V (low logic) and Terminal 9 (Key 2 or Channel 02) to 5 V (high logic) and also turn the Terminal 11 voltage to 12 V. In such a manner, through an external remote signal, the circuitry 1020 allows for the same signals characteristics as if audio signals were provided to the inputs of the circuitry 1025.

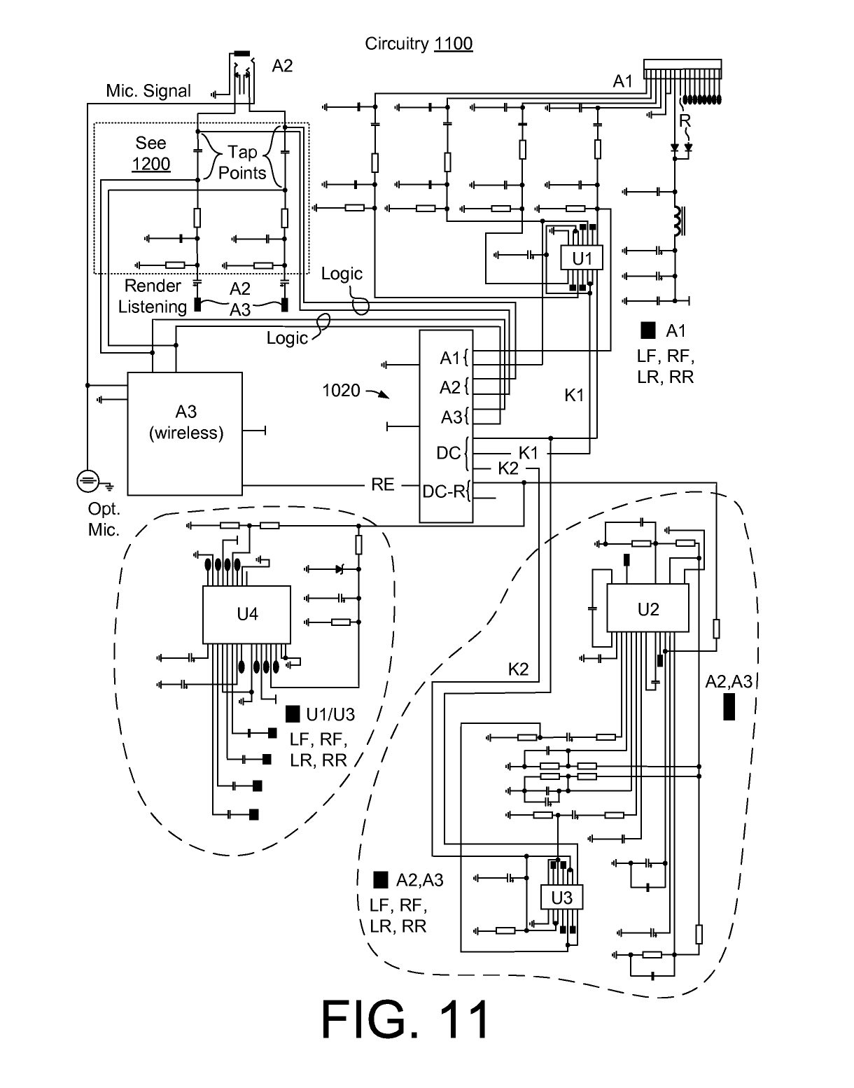

FIG. 11 shows circuitry 1100 as including circuitry 1020 where A1 may be the inputs to circuitry 1023, A2 and A3 the inputs to the circuitry 1025 and RE and DC-R remote inputs. The lines labeled “DC” may include the output logic per Terminals 8 and 9 of the circuitry 1027 of FIG. 10 (see labels K1 and K2).

The circuitry 1100 includes inputs for A1, A2 and A3 where A1 may be input via a wiring harness (e.g., of a vehicle or other system), A2 may be input via a jack and A3 may be input received wirelessly (e.g., via a BLUETOOTH® standard or other wireless reception/communication circuitry). As to specifics on circuitry associated with the inputs A2 and A3, circuitry 1200 of FIG. 12 may be referenced. As to the connector associated with the input for A1, filled ovals can represent signal lines to speakers. In particular, output from the integrated circuit U4, shown as filled ovals, can connect to the filled ovals of the connector associated with A1 to provide audio signals to speakers (e.g., signals amplified at least by the integrated circuit U4).

As shown in FIG. 11, the circuitry 1100 includes logic operative response to audio signals where those same audio signals can be processed and output for listening. In particular, note that the inputs for A1, A2 and A3 each provide paths for logic and paths for signal processing. It is the audio signals themselves, for example, as explained with respect to the circuitry 1020 of FIG. 10, that provides for logical states and, responsive to the logical states, audio signals from one or more media sources can be processed for output.

As examples, consider the tap points for A2 and A3 where paths (e.g., conductor lines) provide received signals to the circuitry 1020 for purposes of “logic” and where other paths provide received signals to circuitry for “listening” or, more generally, processing (see, e.g., filled rectangles for IC U2). Also consider the “DC” outputs K1 (e.g., Terminal 8 or Channel 01) and K2 (e.g., Terminal 9 or Channel 02) of the circuitry 1020 as being directed to switches U1 and U3, respectively. As described in more detail with respect to FIG. 12, the portion of the circuitry that is configured for reception of A2 and A3 may also include priority logic. Specifically, where input is supplied at A2 and A3, the input signals from A3 can act to block transmission of the signals from A2 to the “listening” paths (e.g., via charging of capacitors, etc.). Accordingly, to handle inputs at A1, A2 and A3, some logical decision making may be described as occurring outside of the circuitry 1020 (i.e., as to what “listening” signals are transmitted to the IC U2).

As shown in the example of FIG. 11, the circuitry 1100 includes integrated circuits U1, U2, U3 and U4 where the ICs U1 and U3 are switches and the ICs U2 and U4 are signal processors where signal processing can include amplifying. As indicated by filled rectangles, signals at A2 and A3 can be applied to the IC U2, which, in turn, can be applied to the IC U4 via the IC U3. Thus, the IC U2 may be viewed as being configured to process signals received via inputs A2 and A3.

As an example, the IC U2 may be a tone control circuit with optional volume control circuitry. A commercially available circuit such as the TDA1524 may be suitable for use as the IC U2. Such a circuit can be configured for use as an active stereo-tone/volume control for car radios, TV receivers and mains-fed equipment. The TDA1524 by Philips Semiconductors includes functions for bass and treble control, volume control with built-in contour (can be switched off) and balance. Such functions can be controlled by DC voltages or by single linear potentiometers and may provide for benefits like having few external component requirements, low noise due to internal gain, bass emphasis can be increased by a double-pole low-pass filter, and wide power supply voltage range.

As described herein, input signals via A1 may be much stronger than those via A2 (e.g., A1 5 V and 250 mA while A2 is 250 mV to 3 V with microamps). Accordingly, the IC U2 may be relied upon to condition the signal from A2 (or A3) and provide for enhanced signal quality when compared to a raw signal emanating from a media source such as a cellular phone head/earphone jack.

As described herein, logic circuitry can use a small part of an audio signal (media signal), particularly, the audio information portion of the signal. Filtering out of a DC component may occur to provide just time varying analog audio signal.

Referring again to the circuitry 1020, the logic signals K1 and K2 will turn on switches U1 or U3, responsive to audio signal inputs received via A1, A2 or A3 and transmitted to the circuitry 1020. Note that the switches U1 and U3 provide for switching audio signals for processing by the IC U4, which may be a final stage amplifier, which, in turn, directs processed audio signals to speakers or other transduction devices.

FIG. 12 shows circuitry 1200, which may be provided with circuitry 1100 of FIG. 11. The circuitry 1200 includes some additional components when compared to the portion of circuitry 1100 as to inputs for A2 and A3.

As an example, consider a BLUETOOTH® module that receives a call (e.g., A3). In response, 12 V DC is output via the remote control line (RE). For the capacitor 1CBC, it will immediately charge (e.g., to provide any of a variety of fade out times). Also, saturation will occur for the transistor 1TBC and the transistor 2TBC, which will shut down or block any signal received via A2 (1TBC and 2TBC are referenced to ground). As mentioned, an external microphone may be provided in a user environment such that a user may provide voice (e.g., speak to a caller). As shown in the example of FIG. 12, input circuitry includes a microphone line that can transmit a signal to the wireless module. Accordingly, the microphone may share an input (e.g., a physical jack) with a wired cell phone or device (e.g., via a connection box such as the box 830 of FIG. 8 or the box 930 of FIG. 9). As mentioned, the circuitry 1200 may optionally include a microphone optionally having a line separate from that of the input circuitry for A2 as shown in FIG. 12.

Referring again to the example where a call is received via a BLUETOOTH® module, where there is no longer any control out signal from the BLUETOOTH® module, the capacitor 1CBC will discharge slowly to thereby turn off the transistor 1TBC and the transistor 2TBC where, for example, the turn off time will depend on the value of the capacitor 1CBC. In such a manner, the signal from A2 (if present) will return to the “listening” posts.

In the example of FIG. 12, the diode 1DBC can avoid undesirable discharge of the capacitor 1CBC through the wireless module (i.e., to ensure current flow in one direction only). As to the resistor 1RBC, it provides for polarization on turn on of the transistors 1TBC and 2TBC and, as to the resistor 2RBC, it provides for stabilization of these transistors. As indicated, the transistors 1TBC and 2TBC are NPN transistors that provide for roles of electronic “keys” that are responsible for shutting down an A2 signal by connecting it to ground when the wireless module becomes active due to receipt of a wireless signal (e.g., BLUETOOTH® control output).

As to the resistors 3RBC and 4RBC, these separate the circuit into two portions to avoid shut down of A3 signal input when the transistors 1TBC and 2TBC provide for turning on the A3 signal. Also note, that in the example of FIG. 12, the input for the A2 signal is direct connected to ground through 1TBC and 2TBC and that the side of the A3 signal is about 1000 ohms distant from ground. Accordingly, when 1TBC and 2TBC are “on”, the A3 signal does not suffer any changes.

As an example, consider a cell phone and a portable media player where an average level of about 250 mW and 3 V of output. Power is voltage times current, which provides a current estimate of about 83 mA. As this current is applied to the input of the circuit resistors R15 and R16 (e.g., as both 47 kR), the resultant current will be 63.82 microamperes (e.g., 3/47,000). Accordingly, the potency is 191.46 microwatts.

The logic 260 is reproduced in FIG. 12 to demonstrate how the circuitry 1200 can provide for operational states S6 and S8, where K2 is “on” and the audio signal applied to the processing circuitry is that of A3 rather than A2.

FIG. 13 shows an example of circuitry 1330, which may be circuitry of a connection box such as the connection boxes 830 or 930. As shown, the circuitry 1330 includes two inputs (CN1 and CN2) and one output (P1). The circuitry 1330 also includes microphone circuitry, which may receive voice or other audible signals and transmit these to the output (P1). Further, where a media device is connected via the connector input (CN1) having the microphone circuitry connected thereto, a microphone signal may be received (e.g., via pin 3 of the connector CN1).

FIG. 13 also shows an example of a scenario 1360 that includes various equipment in a vehicle environment. For example, the scenario 1360 can include a device 1310-1, a device 1310-2 and a steering wheel 1361 configured with a so-called push-to-talk circuit (PTT). The input (CN2) of the circuitry 1330 may be configured to receive signals via such specialized circuitry and communicate such signals via wire or wirelessly to another device such as the device 1310-2, which may include logic circuitry or be in communication with logic circuitry (e.g., circuitry 1020 of FIG. 10). As shown in the scenario 1360, a microphone may be provided to allow for voice signals to be transduced and communicated to other circuitry.

As described herein, microphone circuitry may be used to capture ambient sounds and transmit signals to circuitry of a phone, a BLUETOOTH® module, etc. A microphone may have a resistance of about 2200 ohm, as found in microphones fitted to headphone headsets accompanying cellular phone handsets.

In the circuitry 1330, resistors are used to simulate a load (e.g., 32 ohm). Such resistors can “trick” internal circuitry of a portable player or cell phone in a manner such that the circuit “thinks” that there is a standard headset plugged into the audio output jack of the portable device. Such resistors can also avoid a condition referred to as “open collector”, a situation that can cause burning of audio output circuitry of a device (e.g., also for modulating audio echo and distortion).

In operation, the circuitry 1330, for example, by connecting to a headphone output of a portable player, will detect that a source is present (e.g., via load detection) and allow for sending audio to the output connector (P1).

By connecting to a headphone output of a cell phone, the circuitry 1330 will detect (e.g., via the resistors and associated circuitry) that there is a standard headphone connected via a device's audio output, which will enable sending audio signals to the output connector P1 (e.g., and on to logic circuitry).

By connecting to a headphone output of a cell phone, the circuitry 1330 can detect a microphone interface to indicate that there is a cell phone headset connected, thus enabling the sending of audio through the output connector (P1). Also, such a process can provide for allowing clearance of incoming calls in a hands free mode, leaving a user to enable or disable this feature on, for example, a device menu.

With respect to a push-to-talk (PTT) feature, when using a mobile phone that has PTT and that is connected to circuitry 1330 via an input, a radio command switch (e.g., as part of a steering wheel assembly) may be activated, such that a positive pole of the circuitry 1330 microphone interface will be connected to a ground pole. This operation can trigger a cell phone's internal radio command for PTT (push to talk).

Where a cellular phone may not have a PTT feature available, or connected to circuitry such as the circuitry 1330, a radio command switch may be activated in a vehicle environment that can trigger a cellular phone's voice command; noting that not all cellular phones will enable voice command when the PTT button is pressed, but that many work with such a feature.

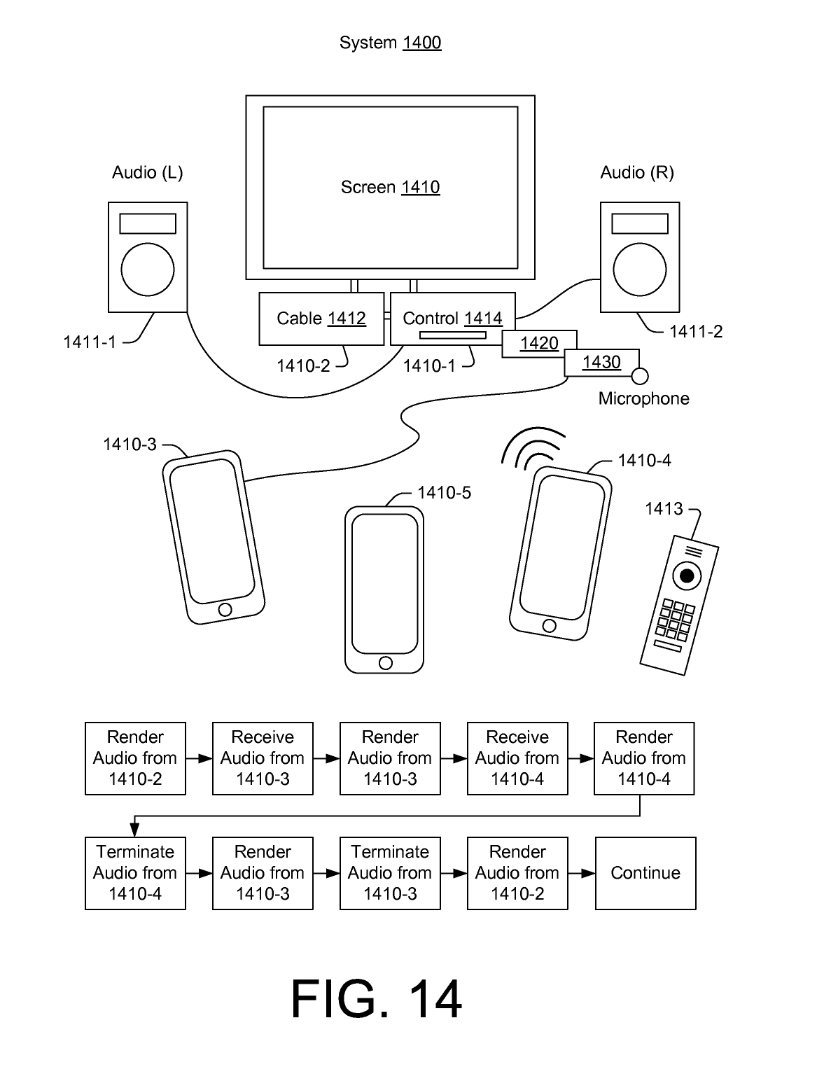

FIG. 14 shows a system 1400 that includes various equipment in a home environment or in an office environment. The system 1400 includes a screen 1410 configured for display of video from one or more media sources such as a cable or satellite unit 1412 or a control unit 1414, which may be configured for Internet communication, reading media such as DVDs, memory cards, etc. As shown, speakers 1411-1 and 1411-2 provide for transducing audio signals, as rendered from a media source via the control unit 1414. Additionally, logic circuitry 1420 and connection circuitry 1430 are provided, which can include a microphone.

The system 1400 may also include a wired cellular phone 1410-3, a BLUETOOTH® standard enabled cellular phone 1410-4 and another cellular phone 1410-5. A remote control 1413 configured for emitting control commands for receipt by the system 1400 may include features such as a microphone, which may operate as an alternative to the microphone shown with respect to the unit 1430.

An example of a method is also shown in FIG. 14 that includes rendering audio from media source 1410-2 (e.g., cable, satellite unit 1412), receiving audio signals from media source 1410-3, rendering audio from media source 1410-3 for listening via the speakers 1411-1 and 1411-2, receiving audio from media source 1410-4, rendering audio from media source 1410-4 for listening via the speakers 1411-1 and 1411-2, terminating audio from media source 1410-4 and rendering audio from media source 1410-3, terminating audio from media source 1410-3 and rendering audio from media source 1410-2, and so on. As described herein, various circuitry of the system 1400 can include logic circuitry, for example, in the form of a state machine, to automatically determine what audio signals from what media sources should be rendered.

Where, for example, in the system 1400 the cell phones 1410-4 and 1410-5 are wireless and configured with a communication protocol (e.g., BLUETOOTH® standard) compatible with the module 1430, handling of calls from these two phones may be appropriately controlled via logic of a protocol (e.g., priority to first received call). Accordingly, in such an example, if the wireless module is in use for the phone 1410-4, user of the phone 1410-5 may simply answer her phone without interruption of any media being rendered (e.g., from the phone 1410-4). Such an arrangement can allow any of a variety of users with phone or other devices configured for wireless transmission of signals to interact with the system 1400. Such an arrangement can be beneficial in, for example, an office environment (e.g., executives in a conference room) where an executive receiving an important call may have the call prioritized over media from another source (e.g., where executives are waiting for a decision on an important deal).

As described herein, a state machine may be included in (e.g., inside) a CD player or DVD player or other media player or an electronic device equipped with A/V (audio and video) inputs and outputs, optionally equipped with a microphone and optionally having capability to recognize audio or video signals through an auxiliary input and then reproducing such a signal automatically to enable, for example, answering of phone calls in a hands-free manner or to change a media device's functional state from off to on upon receipt of medial signal from a media device.

As described herein, a state machine may be included in (e.g., inside) a power amplifier unit or used in conjunction with a power amplifier designed for automotive or home applications. Such implementations may include pre-audio level inputs, a microphone and the capability to recognize audio or video signals and, in response, automatically to enable, for example, answering of phone calls in hands-free manner or to change a media device's functional state from off to on upon receipt of electronic signal from media device.

Although some examples of methods, devices, systems, arrangements, etc., have been illustrated in the accompanying Drawings and described in the foregoing Detailed Description, it will be understood that the example embodiments disclosed are not limiting, but are capable of numerous rearrangements, modifications and substitutions without departing from the spirit set forth and defined by the following claims.

What is claimed is:

1. A state machine comprising:
inputs configured to receive media signals from multiple media sources;
state logic configured to respond to receipt of media signals by the inputs; and
outputs configured to output logical states wherein each of the logical states calls for rendering of media from one of the multiple media sources.

2. The state machine of claim 1 wherein the inputs comprise inputs configured to receive analog media signals.

3. The state machine of claim 1 comprising circuitry configured to transform an analog media signal to a constant voltage signal.

4. The state machine of claim 1 wherein the outputs comprise outputs configured to output constant voltage signals.

5. The state machine of claim 1 wherein the inputs comprise inputs configured to receive analog audio signals.

6. The state machine of claim 5 comprising circuitry configured to transform an analog audio signal to a constant voltage signal.

7. The state machine of claim 1 wherein the inputs comprise inputs configured to receive analog audio signals from a media source configured to output audio and video signals.

8. The state machine of claim 1 wherein the inputs comprise at least one input configured to receive media signals wirelessly.

9. The state machine of claim 1 wherein the state logic comprises priority logic to prioritize at least one of the inputs.

10. The state machine of claim 1 wherein at least one of the multiple media sources comprises a media source configured to receive power from a 12 volt power system.

11. The state machine of claim 1 wherein at least one of the multiple media sources comprises a media source configured to receive power form a lithium ion battery.

12. The state machine of claim 1 wherein the multiple media sources comprise a portable media device and a media device configured to read removable media.

13. The state machine of claim 1 wherein the state machine and at least one of the media sources operate on a common power circuit.

14. The state machine of claim 13 wherein the common power circuit comprises a fuse or circuit breaker.

15. The state machine of claim 13 wherein the common power circuit comprises a vehicle power circuit.

16. The state machine of claim 1 wherein the multiple media sources comprise at least one media source selected from a group consisting of a game device, an audio-video camera, a DVD player, a CD player, a personal computer, a cell phone, a vehicle computer, and a GPS device.

17. The state machine of claim 1 wherein the multiple media sources comprise a cell phone connected by wire to one of the inputs and a cell phone connected wirelessly to one of the inputs.

18. The state machine of claim 1 comprising a RC circuit that comprises transistors, the RC circuit configured to receive media signals via one of the inputs configured for wireless receipt of media signals and to prioritize rendering of media from a media source that provides the media signals wirelessly over media from one or more other media sources.

19. A media player comprising:
an internal media source for providing media signals;
an input configured to receive media signals from an external media source; and
state logic configured to respond to media signals from the internal media source and to media signals from the external media source by calling for rendering of media from the internal media source or rendering of media from the external media source.

20. A media signal amplifier comprising:
inputs configured to receive media signals from multiple media sources; and
state logic configured to respond to receipt of media signals by the inputs by calling for amplification of media from one of the multiple media sources.
